(19) United States
(12) Patent Application Publication
(10) Pub. No.: US 2005/0030592 A1
(43) Pub. Date: Feb. 10, 2005

(54) Coverless scanner

(76) Inventor: Chung-Hua Tsai, Hsinchu (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/635,551

(22) Filed: Aug. 7, 2003

(51) Int. Cl. H04N 1/04

(52) U.S. Cl. 358/474

(57) ABSTRACT

A scanner has a motor, a transmission gear set coupled with the motor, a contact image sensor and a belt connected between the transmission gear set and the contact image sensor. A sensing assembly has a casing adapted to be mounted on a side of a screen and a sensor securely received inside the casing to initiate the motor such that the contact image sensor is also driven to scan.

### BACKGROUND OF THE INVENTION

1. Field of the Invention

The present invention relates to scanner, and more particularly to a coverless scanner so that the operator does not need to open the cover for replacing a new piece of paper to be scanned and is able to scan a new piece of paper simply by placing the paper on top of the screen of the scanner.

2. Description of Related Art

In order to digitize the information on papers, scanners have been developed so that people are able to transmit the scanned information in a way in addition to well-established methods. However, everytime the operator scans a piece of paper, the operator has to lift the cover so that the piece of paper is able to be placed on top of the screen of the scanner. After the cover is closed, the operator has to press a certain button to initiate the movement of the scanning device inside the scanner. Moreover, the scanning device inside the scanner moves lengthwise, which is troublesome and time consuming.

To overcome the shortcomings, the present invention tends to provide an improved scanner to mitigate the aforementioned problems.

### SUMMARY OF THE INVENTION

The primary objective of the present invention is to provide an improved scanner without a cover and provided with a sensor so that everytime there is a piece of paper placed on top of the screen, the sensor sends out a signal to activate the image sensor.

Another objective of the present invention is that the image sensor moves widthwise such that the time required to complete the scanning process is short.

Other objects, advantages and novel features of the invention will become more apparent from the following detailed description when taken in conjunction with the accompanying drawings.

### BRIEF DESCRIPTION OF THE DRAWINGS

FIG. 1 is perspective view showing the internal structure of the scanner of the present invention;

FIG. 2 is perspective view of the scanner of the present invention; and

FIG. 3 is a side view showing the scanner of the present invention.

### DETAILED DESCRIPTION OF THE PREFERRED EMBODIMENT

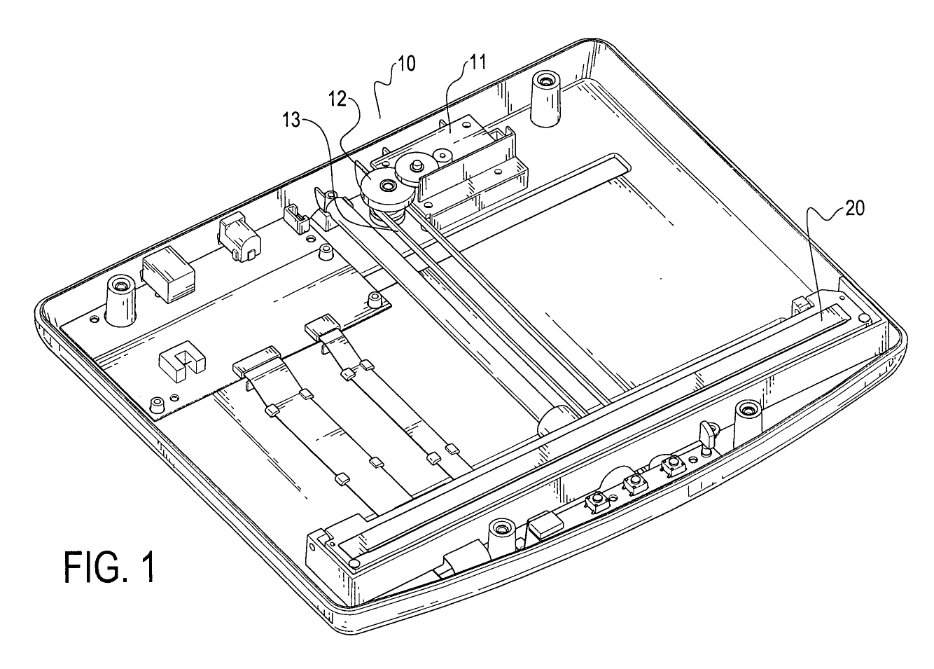

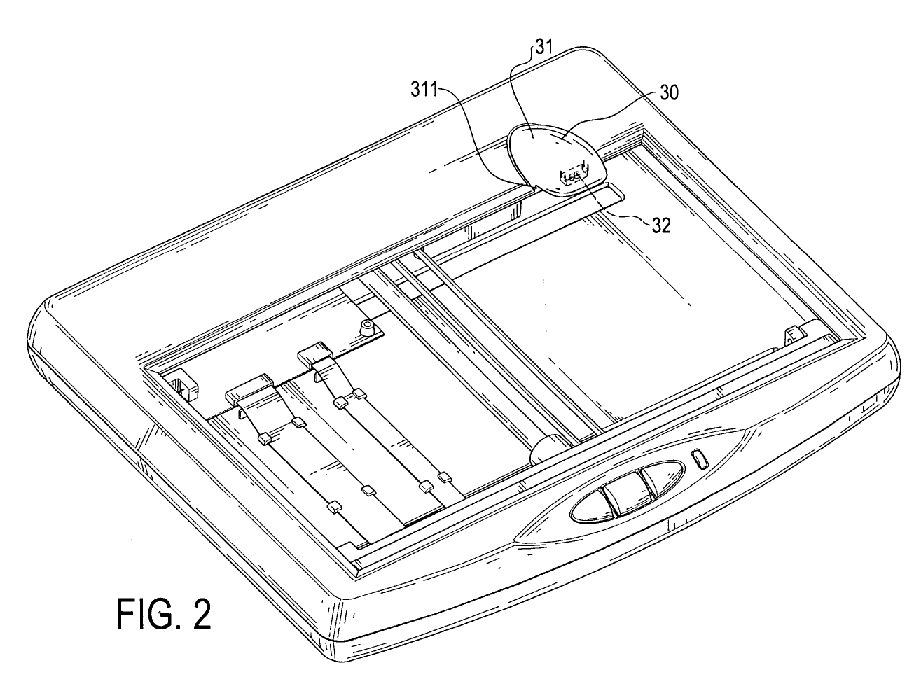

With reference to FIGS. 1 and 2, the scanner in accordance with the present invention includes a transmission assembly (10), a contract image sensor (20) and a sensing assembly (30).

The transmission assembly (10) is composed of a motor (11), a transmission gear set (12) coupled with the motor (11) and a belt (13) connected to the transmission gear set (12),

The contact image sensor (20) is an electronic element which is able to digitize scanned information and conventional in the art so that detailed description thereof is thus omitted.

The sensing assembly (30) includes a casing (31) mounted on a top of the scanner and a sensor (32) securely received inside the casing (31) and electrically connected to the transmission assembly (10).

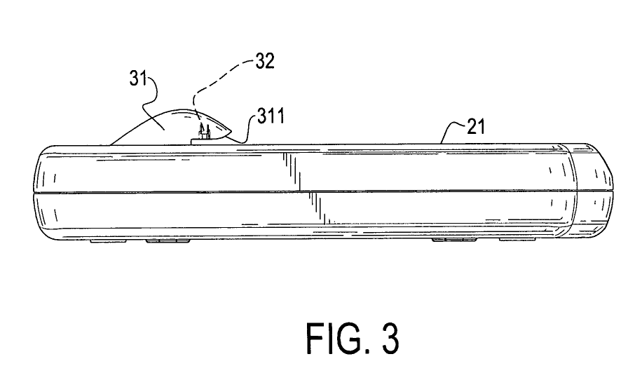

With reference to FIG. 3, it is noted that before the scanner of the present invention is used, the casing (31) is mounted on top of a screen (21) of the contact image sensor (20) and has a recessed area (311) defined in a side of the casing (31).

When the scanner of the present invention is in use, the operator simply places a piece of paper to be scanned on top of the screen (21) and abutted to the recessed area (311) of the casing (31), due to the insertion of the piece of paper in the recessed area (311), the sensor (32) is initiated. After the sensor (32) is initiated, a signal is sent to the transmission assembly (10). Thus the motor (11) is driven to rotate, which drives the transmission gear set (12) and the belt (13). The belt (13) will then drive the contact image sensor (20) to move widthwise, which shortens the time required to finish the entire scanning process.

Therefore, it is noted that the removal of the conventional scanner cover facilitates the continuous operation of the scanner. Furthermore, the lengthwise movement of the contact image sensor is changed to widthwise such that the time required to complete the scanning process is short.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. In a scanner having a motor, a transmission gear set coupled with the motor, a contact image sensor and a belt connected between the transmission gear set and the contact image sensor, the improvement comprises:
a sensing assembly has a casing adapted to be mounted on a side of a screen and a sensor securely received inside the casing to initiate the motor such that the contact image sensor is driven to scan.

2. The scanner as claimed in claim 1, wherein the casing has a width and a recessed area defined in a side of the casing for receiving therein a piece of paper,
the contact image sensor has a widthwise travel.
